(19) United States
(12) Patent Application Publication
(10) Pub. No.: US 2026/0113577 A1
(43) Pub. Date: Apr. 23, 2026

(54) ACOUSTIC DEVICE

(71) Applicant: ALPS ALPINE CO., LTD., Tokyo (JP)

(72) Inventor: Ryo ITO, Fukushima (JP)

(21) Appl. No.: 19/360,327

(22) Filed: Oct. 16, 2025

(30) Foreign Application Priority Data
Oct. 23, 2024 (JP) 2024-186367

(51) Int. Cl. H04R 9/02; H04R 1/02; H04R 9/06

(52) U.S. Cl. CPC H04R 9/025; H04R 1/025; H04R 9/06; H04R 2400/11; H04R 2499/13

(57) ABSTRACT

An acoustic device includes a box and a speaker unit accommodated in an internal space of the box, wherein the box includes a front wall having an opening and a rear wall facing the front wall, the speaker unit includes a frame, a diaphragm supported on the frame so as to be capable of vibrating, a voice coil configured to vibrate together with the diaphragm, and a magnetic circuit configured to apply a magnetic field to the voice coil, the magnetic circuit includes a magnet and a yoke made of a magnetic material, a magnetic gap in which the voice coil is disposed is formed in a part of the yoke, the opening is configured to allow sound pressure emitted from the diaphragm to be released to an external space, and a part of the yoke is disposed within the rear wall.

### CROSS-REFERENCE TO RELATED APPLICATION

The present application is based on and claims priority to Japanese patent application No. 2024-186367 filed on October 23, 2024, with the Japan Patent Office, the entire contents of which are hereby incorporated by reference.

### BACKGROUND OF THE INVENTION

### 1. Field of the Invention

The disclosures herein relate to on-vehicle acoustic devices in which speaker units are built in thin boxes.

### 2. Description of the Related Art

Paragraph [0002] of Patent Literature (PTL) 1 discloses that, in vehicle-mounted speaker systems, when heavy bass reproduction is desired, a method is employed in which a subwoofer housed in a large cabinet is installed in the trunk of a vehicle. However, in cases where the large cabinet cannot be installed, such as when the vehicle is small or when it is undesirable to sacrifice trunk space, an alternative method is used in which a vibration actuator is mounted to a floor beneath a seat to cause the floor to vibrate. In such a configuration, the vehicle interior is utilized as an enclosure for sound reproduction.

FIG. 4 of PTL 1 illustrates an example of the vibration actuator. This vibration actuator is provided with a yoke on an inner bottom surface of a case fixed to the floor surface of the vehicle. The yoke is formed with a pole at the center and a flange at the bottom, the flange being fixed to the inner bottom surface of the case. A ring-shaped magnet is fixed on the flange of the yoke, and a top plate with a large hole is fixed on the magnet. A magnetic gap is formed between the pole of the yoke and the hole of the top plate. A frame is fixed on the top plate, a voice coil bobbin is supported on the frame by two butterfly dampers, and a voice coil wound on the lower end of the voice coil bobbin is positioned in the magnetic gap. A weight to which the upper end of the voice coil bobbin is connected is supported by the butterfly dampers. In this vibration actuator, a low-frequency component of an audio signal is applied to the voice coil, the weight vibrates up and down, and the vibration of the weight is transmitted to the floor surface of the vehicle.

Since the vibration actuator described in PTL 1 is arranged in a space with no margin of height in a vehicle such as a floor beneath a seat, it is required to have a thin case. In order to obtain an effective vibrating force in a low frequency range, a large magnet for vibrating a weight vertically with a large amplitude is required, and a space for arranging a large magnet and a weight operating with a large amplitude must be secured in an internal space of the case, which has a limit in reducing the thickness of the case.

As an on-vehicle acoustic device, what is called a powered woofer in which a speaker unit operating as a woofer and an electronic device such as an amplifier are housed in a box is used, and this powered woofer is also installed in a space with no margin of height such as a floor beneath a seat. Also in the powered woofer, since it is necessary to vibrate a diaphragm of the speaker unit with a large amplitude in a low frequency range, as in the case of the vibration actuator described in PTL 1, there is a problem that it is difficult to reduce the top-bottom thickness of the box.

The present disclosure aims to solve the above conventional problems, and to provide an acoustic device capable of securing a space for arranging a magnetic circuit including a relatively large driving magnet inside a box, and further reducing the thickness of the box.

### CITATION LIST

### PATENT LITERATURE

[PTL 1] Japanese Laid-Open Patent Publication No. H10-294979

### SUMMARY OF THE INVENTION

An acoustic device includes a box and a speaker unit accommodated in an internal space of the box, wherein the box includes a front wall having an opening and a rear wall facing the front wall, the speaker unit includes a frame, a diaphragm supported on the frame so as to be capable of vibrating, a voice coil configured to vibrate together with the diaphragm, and a magnetic circuit configured to apply a magnetic field to the voice coil, the magnetic circuit includes a magnet and a yoke made of a magnetic material, a magnetic gap in which the voice coil is disposed is formed in a part of the yoke, the opening is configured to allow sound pressure emitted from the diaphragm to be released to an external space, and a part of the yoke is disposed within the rear wall.

In the acoustic device of the present disclosure, a part of the yoke included in the magnetic circuit in the speaker unit is disposed within the rear wall of the box. Therefore, the box can be configured as thin as possible without reducing the thickness of the magnetic circuit.

### BRIEF DESCRIPTION OF THE DRAWINGS

FIG. 1 is a perspective view illustrating an acoustic device according to a first embodiment of the present disclosure viewed from the front;

FIG. 2 is a longitudinal cross-sectional view illustrating the acoustic device shown in FIG. 1 cut along a line II-II;

FIG. 3A is an enlarged partial cross-sectional view illustrating the acoustic device shown in FIG. 2;

FIG. 3B is an enlarged partial cross-sectional view illustrating a step of assembling a speaker unit on a rear wall of a box;

FIG. 4A is an enlarged partial cross-sectional view of the acoustic device according to a modified example of the first embodiment;

FIG. 4B is an enlarged partial cross-sectional view illustrating a step of assembling a speaker unit on a rear wall of a box of the acoustic device according to the modified example of the first embodiment;

FIG. 5A is an enlarged partial cross-sectional view of the acoustic device according to another modified example of the first embodiment;

FIG. 5B is an enlarged partial cross-sectional view illustrating a step of assembling a speaker unit on a rear wall of a box of the acoustic device according to the other modified example of the first embodiment;

FIG. 6A is a partial enlarged cross-sectional view illustrating a preferable size of an auxiliary plate included in a yoke of a magnetic circuit of FIG. 3A;

FIG. 6B is a partial enlarged cross-sectional view illustrating a preferable size of an auxiliary plate included in a yoke of a magnetic circuit of FIG. 5A; and

FIG. 7 is a partial enlarged cross-sectional view illustrating a second embodiment of the present disclosure.

### DESCRIPTION OF THE PREFERRED EMBODIMENTS

An acoustic device 1 and 101 according to an embodiment of the present disclosure is a vehicle-mounted powered woofer, and is mounted on a vehicle floor within a vehicle interior, for example, in a space beneath a seat. In the acoustic device 1, a Y1-Y2 direction is a front-rear direction, and a Y1 direction is a front direction and a Y2 direction is a rear direction. A main sound generation direction is the front direction (Y1 direction).

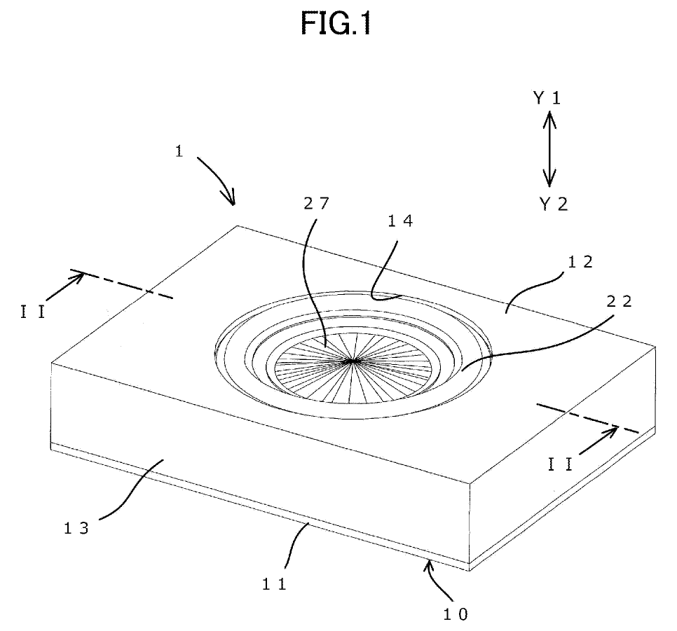

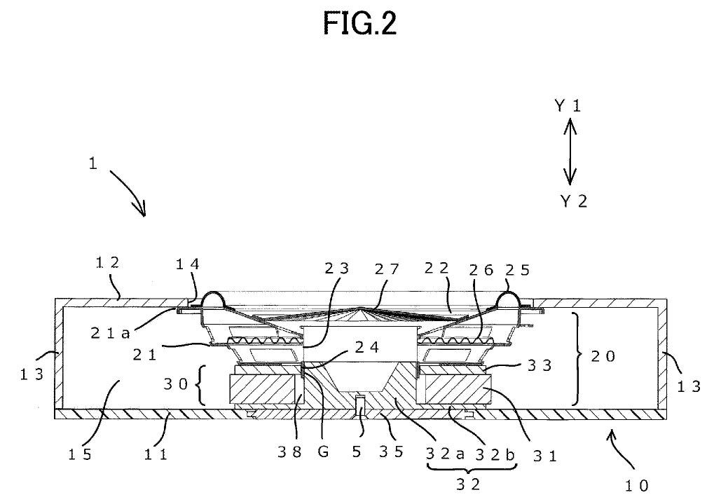

As shown in FIGS. 1 to 3B, the acoustic device 1 of the first embodiment has a box 10. As shown in FIG. 2, the box 10 has a rear wall 11 positioned rearward (in the Y2 direction), a front wall 12 positioned forward (in the Y1 direction) facing the rear wall 11, and lateral walls 13 covering four lateral surfaces. The rear wall 11 is a bottom plate formed of a synthetic resin material or a non-magnetic metal material. The front wall 12 and the four lateral walls 13 are seamlessly formed of a synthetic resin material or a metal material. As shown in FIG. 1, a circular opening 14 is formed in the front wall 12 so as to penetrate the front wall 12 in the front-rear direction. As shown in FIG. 2, an internal space 15 of the box 10 is formed by covering the rear wall 11 with the seamlessly formed front wall 12 and the lateral walls 13. The internal space 15 is a parallelepiped and functions as an enclosure in the acoustic device 1. The internal space 15 incorporates a speaker unit 20 operating as a subwoofer and electronic devices including an amplifier circuit and a power supply circuit for driving the speaker unit 20.

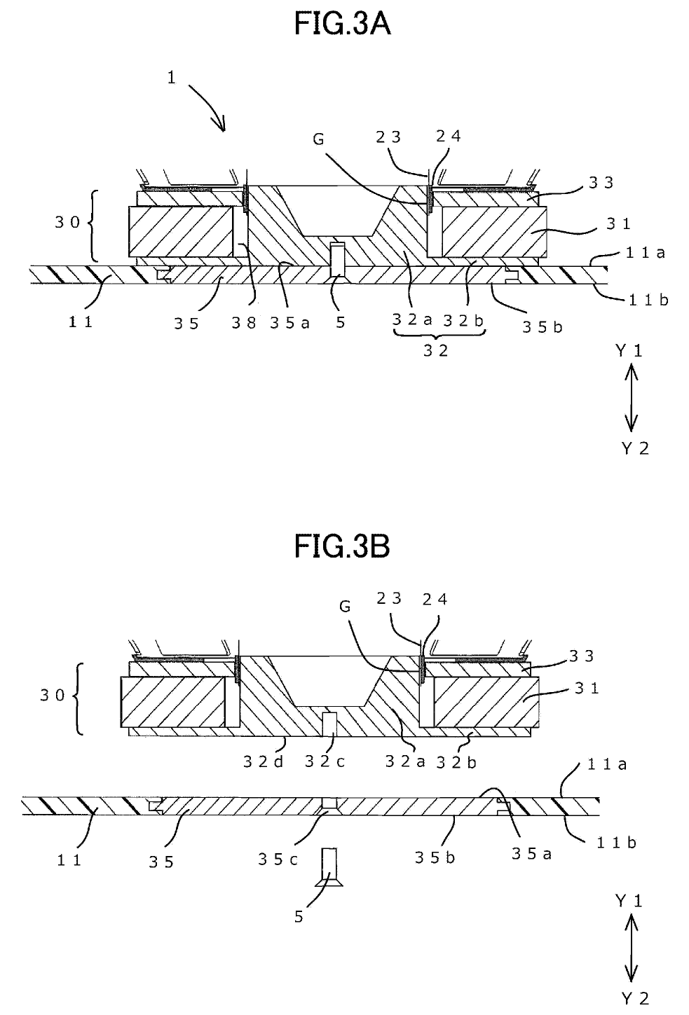

As shown in FIG. 2, the speaker unit 20 has a frame 21. The frame 21 is formed of a non-magnetic material or a magnetic material, and has a tapered shape in which the diameter gradually increases toward the front (Y1 direction). A magnetic circuit 30 is fixed to the rear (Y2 direction) of the frame 21. The magnetic circuit 30 is what is called an external magnetic type and has a ring-shaped driving magnet 31. A center yoke 32 is provided in the magnetic circuit 30. The center yoke 32 is seamlessly formed with a center pole 32a positioned inside the driving magnet 31 and a rear plate 32b projecting from the rear of the center pole 32a to the periphery, and the driving magnet 31 is fixed to the front surface of the rear plate 32b. A ring-shaped front plate 33 is fixed to the front surface of the driving magnet 31. The front plate 33 is positioned at the outer peripheral part of the center pole 32a, and a magnetic gap G is formed between the inner peripheral surface of the front plate 33 and the outer peripheral surface of the center pole 32a. As shown in FIGS. 2 and 3A, a part of the rear portion of the yoke included in the magnetic circuit 30 serves as an auxiliary plate 35. The auxiliary plate 35 is separated from the other portions of the yoke, and the auxiliary plate 35 is magnetically coupled to the rear surfaces of the center pole 32a and the rear plate 32b. The center yoke 32, the front plate 33, and the auxiliary plate 35 constitute a yoke of the magnetic circuit 30, and they are formed of a magnetic material, that is, a magnetic metal material such as iron.

As shown in FIGS. 3A and 3B, the auxiliary plate 35 and the rear wall 11 of the box 10 are seamlessly integrated using insert molding. That is, the auxiliary plate 35 is held in a cavity of a mold, and a molten resin material is injected into the cavity, whereby the rear wall 11 and the auxiliary plate 35 are seamlessly integrated. As shown in FIG. 3B, the front surface 35a of the auxiliary plate 35 is flush with the front surface 11a of the rear wall 11, and the rear surface 35b of the auxiliary plate 35 is flush with the rear surface 11b of the rear wall 11. Although the rear surface 35b of the auxiliary plate 35 may be covered with a part of the resin material constituting the rear wall 11, the thickness of the auxiliary plate 35 included in a part of the yoke can be maximized by making the rear surface 35b of the auxiliary plate 35 flush with the rear surface 11b of the rear wall 11.

As shown in FIG. 2, a diaphragm 22 is provided inside the frame 21 of the speaker unit 20. The diaphragm 22 is tapered (cone-shaped), and a bobbin 23 is fixed to the center of the diaphragm 22. A voice coil 24 is wound around the rear end of the bobbin 23, and the voice coil 24 is inserted into the magnetic gap G of the magnetic circuit 30. A cap member 27 for covering a hollow part of a cylinder of the bobbin 23 from the front is connected to the front surface of the diaphragm 22. The outer peripheral part of the diaphragm 22 is supported by the frame 21 through an elastically deformable edge member 25, and the outer peripheral surface of the bobbin 23 is supported by the frame 21 through an elastically deformable damper member 26. By elastic deformation of the edge member 25 and the damper member 26, a vibrating part including the diaphragm 22, the bobbin 23, and the voice coil 24 is supported so as to be capable of vibrating in the front-rear direction (Y1-Y2 direction). The magnetic circuit 30 and the voice coil 24 constitute a magnetic driving portion for driving the vibrating part including the diaphragm 22 in the front-rear direction.

As shown in FIG. 3B, a female screw hole 32c is formed in the rear surface 32d of the center pole 32a of the center yoke 32, and a screw insertion hole 35c is formed in the auxiliary plate 35. In an assembling process of the acoustic device 1, the speaker unit 20 is installed on the front surface 35a of the auxiliary plate 35. The rear surface 32d of the center yoke 32 is attracted to the front surface 35a of the auxiliary plate 35 by the magnetic force of the driving magnet 31, and a fixing screw 5 is further inserted into the screw insertion hole 35c and screwed into the female screw hole 32c, whereby the speaker unit 20 is fixed to the front surface 35a of the rear wall 35. Then, the center yoke 32 and the auxiliary plate 35 are magnetically coupled, and the auxiliary plate 35 functions as a part of the yoke of the magnetic circuit 30.

After the speaker unit 20 is fixed to the front surface 35a of the auxiliary plate 35, the speaker unit 20 is covered with the upper part of the box in which the front wall 12 and the lateral walls 13 are seamlessly integrated, and the lateral walls 13 are fixed to the rear wall 11. At this time, as shown in FIG. 2, the front end peripheral portion 21a of the frame 21 of the speaker unit 20 abuts against the outer peripheral inner surface of the opening 14 in the front wall 12. As a result, the diaphragm 22 and the cap member 27 of the speaker unit 20 appear within the opening 14, and sound pressure generated by vibration of the diaphragm 22 can be released through the opening 14 to the external space in the front (Y1 direction).

In the acoustic device 1 operating as a powered woofer, a low-frequency component of an audio signal is applied to the voice coil 24 from an amplifier circuit of an electronic device built in the box 10, and the diaphragm 22 vibrates back and forth at a low frequency. Since the internal space 15 of the box 10 is a sealed space having a small volume, air in the internal space 15 readily functions as a damper for reducing vibration of the diaphragm 22. In order to drive the diaphragm 22 with a large amplitude against resistance of air, it is required to increase the mass of the vibration system including the diaphragm 22 and to use a large and powerful driving magnet 31 for driving a heavy vibration system. In addition, in order to reduce demagnetization, it is necessary to increase the thickness of the driving magnet 31 in a magnetization direction, that is, the front-rear direction. Therefore, although the front-rear thickness of the magnetic circuit 30 becomes large, in this acoustic device 1, since the auxiliary plate 35 embedded in the rear wall 11 of the box 10 functions as a part of the yoke, the space in the front-rear direction occupied by the magnetic circuit 30 in the internal space 15 of the box 10 can be reduced, and the overall thickness of the box 10 can be reduced.

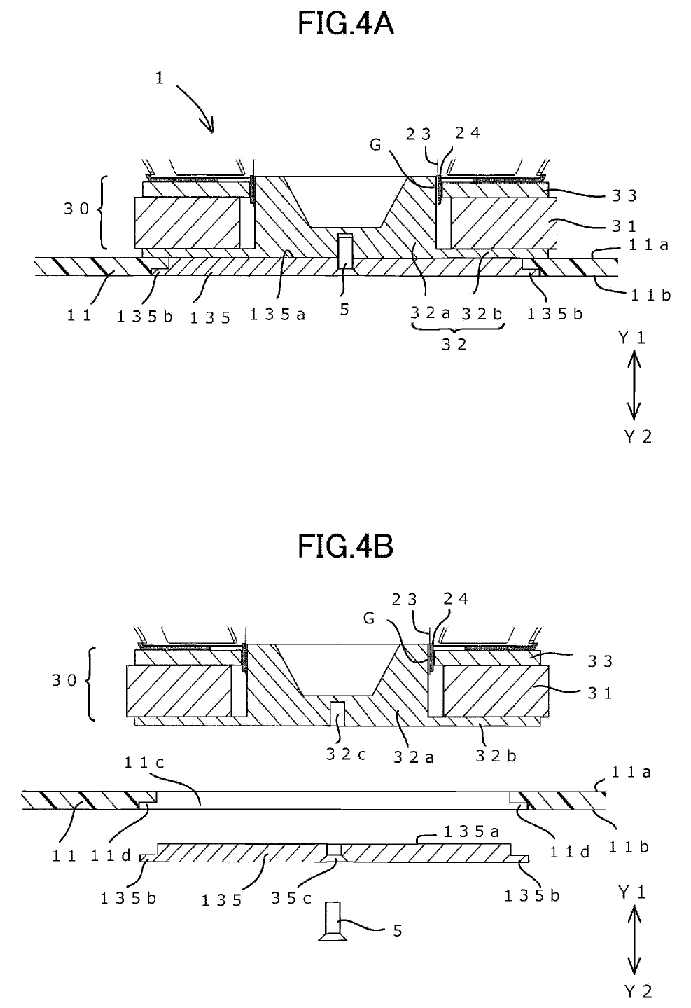

FIGS. 4A and 4B show modified examples of the acoustic device 1 according to the first embodiment. In the acoustic device 1 shown in FIG. 4A and 4B, a circular hole 11c is opened in the rear wall 11 of the box 10. A step part 11d in which the hole 11c expands toward the rear (Y2 direction) is formed in the peripheral edge of the hole 11c. The auxiliary plate 135 is formed separately from the center yoke 32 and separately also from the rear wall 11. A flange 135b projecting from the rear of the peripheral edge toward the periphery is formed in the auxiliary plate 135.

In the assembling process of the acoustic device 1, as shown in FIG. 4B, the speaker unit 20 is installed in the front surface 11a of the rear wall 11 from the front, and the auxiliary plate 135 is inserted into the hole 11c of the rear wall 11 from the rear. As shown in FIG. 4A, when the flange 135b of the auxiliary plate 135 is fitted into the step part 11d of the peripheral edge of the hole 11c, the auxiliary plate 135 is positioned with respect to the rear wall 11, and the front surface 11a of the rear wall 11 and the front surface 135a of the auxiliary plate 135 become flush with each other. While the center yoke 32 and the auxiliary plate 135 are attracted to each other by the magnetic force of the driving magnet 31, the center yoke 32 and the auxiliary plate 135 are fixed to each other by a fixing screw 5.

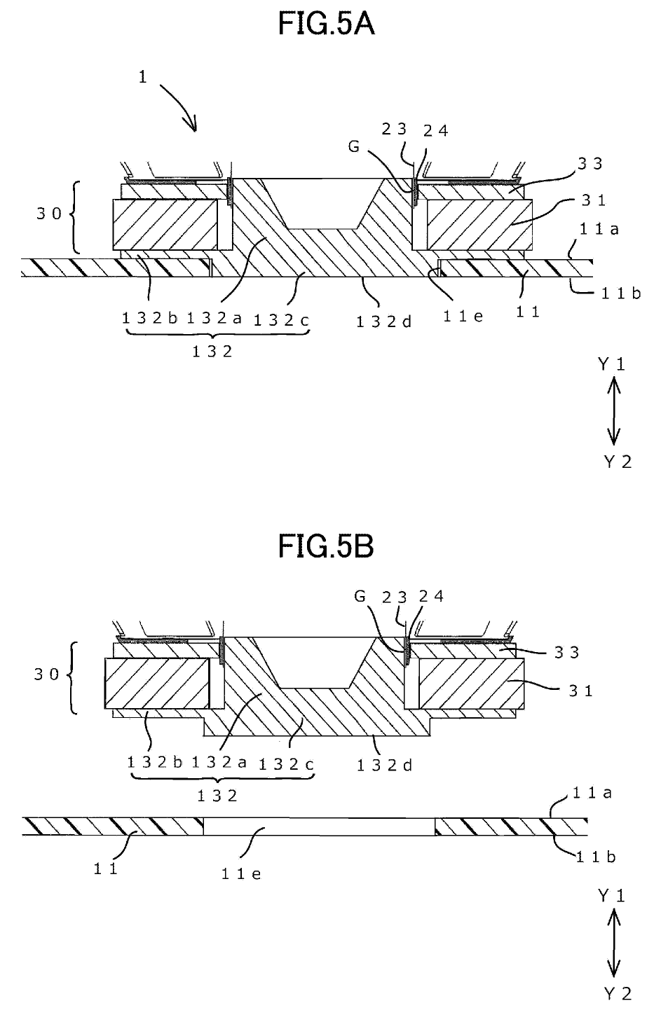

FIGS. 5A and 5B illustrate another modified example of the acoustic device 1 of the first embodiment. In this acoustic device 1, a center pole 132a and a rear plate 132b projecting from the rear of the center yoke 132 to the periphery are formed in a center yoke 132 provided in a magnetic circuit 30, and an auxiliary plate 132c projecting rearward from the center pole 132a and the rear plate 132b is seamlessly formed. As shown in FIG. 5B, a circular hole 11e penetrating the rear wall 11 in the front-rear direction is formed in the rear wall 11. In the assembling process, the speaker unit 20 is assembled to the rear wall 11 from the front, and the auxiliary plate 132c projecting from the center yoke 132 is inserted into the hole 11e of the rear wall 11. The rear plate 132b and the rear wall 11 are fixed by bonding or screwing. As shown in FIG. 5A, when the assembling is completed, the rear surface 132d of the auxiliary plate 132c and the rear surface 11b of the rear wall 11 are flush with each other.

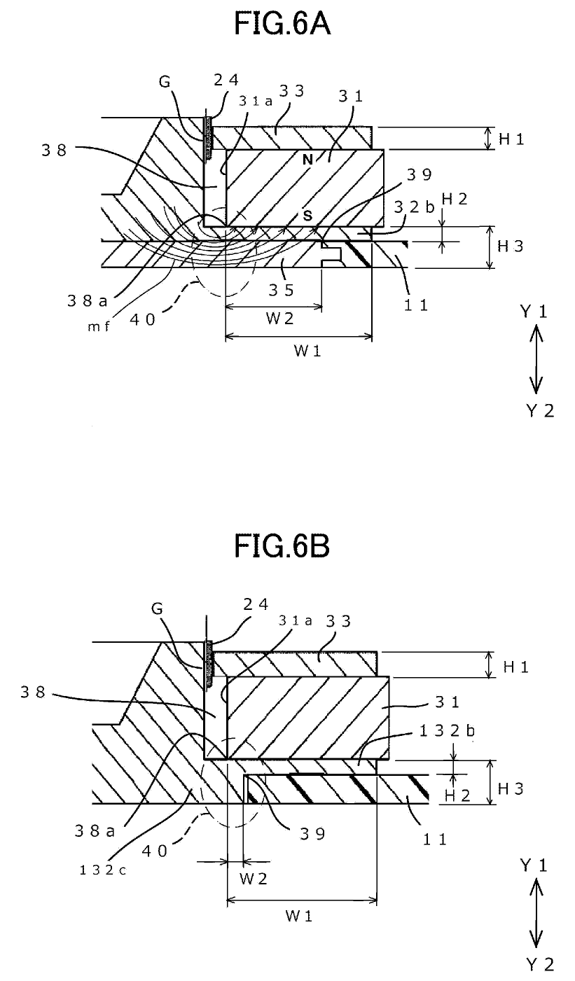

FIG. 6A is a partial enlarged cross-sectional view of FIG. 3A. The front-rear thickness H2 of the rear plate 32b is smaller than the thickness of the front plate 33. The sum H3 of the front-rear thicknesses of the rear plate 32b and the auxiliary plate 35 is equal to or greater than the thickness H1 of the front plate 33. FIG. 6B is a partial enlarged cross-sectional view of FIG. 5A, but also in FIG. 6B, the thickness H2 of the rear plate 132b in the front-rear direction is smaller than the thickness H1 of the front plate 33. The sum H3 of the front-rear thicknesses of the rear plate 32b and the auxiliary plate 132c is equal to or larger than the thickness H1 of the front plate 33. In the acoustic device 1, since the rear plates 32b and 132b are thin, the space in the front-rear direction can be saved in the internal space 15 of the box 10, but since the sums of the thicknesses of the rear plates 32b and 132b and the auxiliary plate 35 and 132c are large, the magnetic saturation of the magnetic flux circulating in the yoke in the magnetic circuit 30 can be reduced.

As shown in FIG. 6A, a gap 38 extending rearward (in the Y2 direction) from the magnetic gap G is formed in the magnetic circuit 30, and an inner surface 38a on the outer side of the gap 38 conforms to the inner surface 31a of the driving magnet 31 (the inner surface of the central hole of the ring-shaped driving magnet 31). In FIG. 6A, magnetic flux lines mf flowing in the yoke of the magnetic circuit 30 are schematically shown, and in the yoke behind the driving magnet 31, magnetic flux density is high in a region 40 near the inner surface 38a on the outer side of the gap 38, so that magnetic saturation is likely to occur. Therefore, it is necessary that the rear plate 32b and the auxiliary plate 35 overlap at the position of the inner surface 38a on the outer side of the gap 38. That is, a contact part 39 between the outer end of the auxiliary plate 35 and the rear plate 32b is required to be disposed outward (on the outer peripheral side) of the inner surface 38a on the outer side of the gap 38. In the cross-sectional view shown in FIG. 6A, if the width between the inner surface 38a on the outer side of the gap 38 and the contact part 39 is referred to as W2, and the width between the inner surface 38a on the outer side of the gap 38 and the outer peripheral end of the rear plate 32b is referred to as W1, it is required that W2 is greater than zero and equal to or less than W1 (W1 ≥ W2 > 0).

In FIG. 6B, the contact part 39 between the outer end of the auxiliary plate 35 and the rear plate 132b approaches the inner surface 38a on the outer side of the gap 38, and the width W2 is equal to or less than a quarter of the width W1. Also in this modification, since the rear plate 132b and the auxiliary plate 132c overlap on the inner surface 38a on the outer side of the gap 38 and the thickness dimension of the yoke is increased to H3, magnetic saturation hardly occurs in the region 40 near the position of the inner surface 38a on the outer side of the gap 38 having a high magnetic flux density.

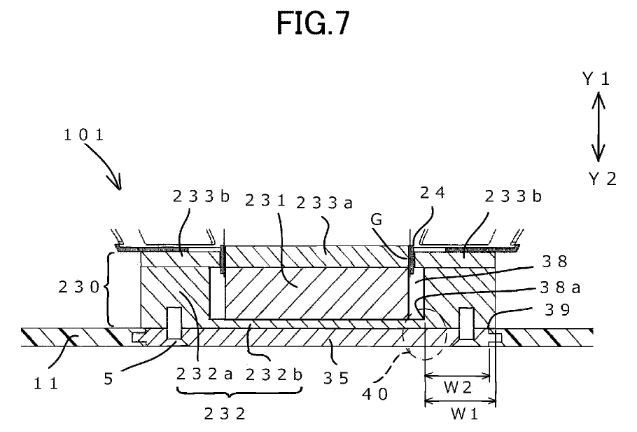

FIG. 7 is a partial enlarged cross-sectional view illustrating an acoustic device 101 according to a second embodiment of the present disclosure. A magnetic circuit 230 of a speaker unit provided in the acoustic device 101 is what is called an internal magnetic type. The driving magnet 231 is positioned inside the magnetic gap G, and a front inner plate 233a is fixed in front of the driving magnet 231. A rear yoke 232 is fixed behind the driving magnet 231. In the rear yoke 232, a rear plate 232b fixed to the rear surface of the driving magnet 231 and an outer peripheral yoke 232a positioned on the outer peripheral side are seamlessly integrated. An auxiliary plate 35 is embedded in the rear wall 11 using insert molding, the rear plate 232b and the auxiliary plate 35 are magnetically coupled, and the rear plate 232b and the auxiliary plate 35 are fixed by fixing screws 5.

In the internal magnetic circuit 230 shown in FIG. 7, the magnetic flux density passing through the yoke is also high in a region 40 including the inner surface 38a on the outer side of the gap 38. In the acoustic device 101, the rear plate 232b and the auxiliary plate 35 are overlapped at the position of the inner surface 38a on the outer side of the gap 38 continuing rearward from the magnetic gap G, so that the thickness of the yoke formed rearward of the driving magnet 231 in the front-rear direction is increased. Therefore, the internal resistance to the magnetic flux in the region can be reduced.

What is claimed is:

1. An acoustic device comprising:
a box; and
a speaker unit accommodated in an internal space of the box, wherein:
the box includes a front wall having an opening and a rear wall facing the front wall;
the speaker unit includes a frame, a diaphragm supported on the frame so as to be capable of vibrating, a voice coil configured to vibrate together with the diaphragm, and a magnetic circuit configured to apply a magnetic field to the voice coil;
the magnetic circuit includes a magnet and a yoke made of a magnetic material;
a magnetic gap in which the voice coil is disposed is formed in a part of the yoke;
the opening is configured to allow sound pressure emitted from the diaphragm to be released to an external space; and
a part of the yoke is disposed within the rear wall.

2. The acoustic device according to claim 1, wherein:
the yoke includes a front plate in contact with a front of the magnet, a rear plate in contact with a rear of the magnet, and an auxiliary plate located within the rear wall; and
the rear plate and the auxiliary plate are magnetically coupled.

3. The acoustic device according to claim 2, wherein:
a front-rear thickness of the rear plate is smaller than a front-rear thickness of the front plate; and
a sum of front-rear thicknesses of the rear plate and the auxiliary plate is equal to or greater than the front-rear thickness of the front plate.

4. The acoustic device according to claim 2, wherein:
a gap extending rearward from the magnetic gap is formed in the yoke; and
a contact part between an outer end of the auxiliary plate and the rear plate is disposed outward of an inner surface on an outer side of the extending gap.

5. The acoustic device according to claim 2, wherein the auxiliary plate is formed separately from the rear plate.

6. The acoustic device according to claim 5, wherein the auxiliary plate is embedded within the rear wall using insert molding.

7. The acoustic device according to claim 5, wherein:
a hole is formed in the rear wall; and
the auxiliary plate is inserted into the hole.

8. The acoustic device according to claim 2, wherein:
the rear plate and the auxiliary plate are seamlessly formed; and
the auxiliary plate is disposed within a hole formed in the rear wall.

9. The acoustic device according to claim 1, wherein an electronic device is incorporated in the box together with the speaker unit.
